(19) United States
(12) Patent Application Publication
(10) Pub. No.: US 2016/0040006 A1
(43) Pub. Date: Feb. 11, 2016

(54) ALDEHYDE SCAVENGERS AND METHODS FOR MAKING AND USING SAME

(71) Applicant: Georgia-Pacific Chemicals LLC, Atlanta, GA (US)

(72) Inventors: Steven K. Harriman, Taylorsville, MS (US); Robert A. Breyer, Atlanta, GA (US)

(73) Assignee: Georgia-Pacific Chemicals LLC, Atlanta, GA (US)

(21) Appl. No.: 14/820,582

(22) Filed: Aug. 7, 2015

Related U.S. Application Data
(60) Provisional application No. 62/034,384, filed on Aug. 7, 2014.

(51) Int. Cl. C08L 61/24

(52) U.S. Cl. CPC C08L 61/24

(57) ABSTRACT

Aldehyde scavengers, binder compositions including the aldehyde scavengers, and methods for making and using same. The aldehyde scavenger can include a urea-formaldehyde resin having a formaldehyde to urea molar ratio of about 1.5:1 to about 2.2:1, a sulfite compound, an ammonium salt, free urea, and a liquid medium. The aldehyde scavenger can have a total formaldehyde to total urea molar ratio of about 0.3:1 to about 0.8:1. The aldehyde scavenger can include about 0.5 wt % to about 4 wt % of the sulfite compound and about 0.5 wt % to about 4 wt % of the ammonium salt, based on a combined weight of the urea-formaldehyde resin, the sulfite compound, the ammonium salt, the free urea, and the liquid medium. The binder compositions can include the aldehyde scavenger and one or more aldehyde-based resins.

### CROSS-REFERENCE TO RELATED APPLICATION

This application claims priority to U.S. Provisional Patent Application No. 62/034,384, filed on Aug. 7, 2014, which is incorporated by reference herein.

### BACKGROUND

1. Field

Embodiments described generally relate to aldehyde scavengers, binder compositions that include the aldehyde scavenger and one or more aldehyde-based resins, and methods for making and using same.

2. Description of the Related Art

Typical adhesives used in the production of lignocellulose composite products such as medium density fiberboard, plywood, and particle board include aldehyde-based resins such as urea-formaldehyde (“UF”), melamine-formaldehyde (“MF”), and melamine-urea-formaldehyde (“MUF”) resins. While these resins produce lignocellulose composite products having desirable properties, they can release formaldehyde into the environment during the production of the resin, the curing of the resin, the lifespan of the lignocellulose composite product, and the incineration of the lignocellulose composite product at the end of its lifecycle.

Various techniques have been used to reduce the amount of aldehydes released from aldehyde-based resins and products made therewith. One such technique is the addition of an aldehyde scavenger, e.g., urea, to the aldehyde-based resin. For example, urea in the form of an aqueous solution can be used as an aldehyde scavenger. Urea solutions having a high concentration of urea, e.g., 40% aqueous urea solution, however, are susceptible to having the urea precipitate out of solution and it is generally undesirable to use solutions having lower concentrations of urea because of the increased water associated therewith.

There is a need, therefore, for improved aldehyde scavengers and methods for making and using same.

### SUMMARY

Aldehyde scavengers, binder compositions that include the aldehyde scavengers and one or more aldehyde-based resins, and methods for making and using same are provided. In at least one specific embodiment, the aldehyde scavenger can include a urea-formaldehyde resin that can have a formaldehyde to urea molar ratio of about 1.5:1 to about 2.2:1, a sulfite compound, an ammonium salt, free urea, and a liquid medium. The aldehyde scavenger can have a total formaldehyde to total urea molar ratio of about 0.3:1 to about 0.8:1. The aldehyde scavenger can include about 0.5 wt % to about 4 wt % of the sulfite compound and about 0.5 wt % to about 4 wt % of the ammonium salt, based on a combined weight of the urea-formaldehyde resin, the sulfite compound, the ammonium salt, the free urea, and the liquid medium.

In at least one specific embodiment, the aldehyde scavenger can include a urea-formaldehyde resin that can have a formaldehyde to urea molar ratio of about 1.5:1 to about 1.8:1, sodium sulfite, ammonium sulfate, free urea, and water. The aldehyde scavenger can have a total formaldehyde to total urea molar ratio of about 0.3:1 to about 0.6:1. The aldehyde scavenger can include about 0.5 wt % to about 2.5 wt % of the sodium sulfite and about 0.5 wt % to about 2.5 wt % of the ammonium sulfate, based on a combined weight of the urea-formaldehyde resin, the sodium sulfite, the ammonium sulfate, the free urea, and the water. The aldehyde scavenger can also have a pH of about 7 to about 9 at a temperature of about 25° C. and a solids content of about 60 wt % to about 70 wt %, based on a combined weight of the urea-formaldehyde resin, the sodium sulfite, the ammonium sulfate, the free urea, and the water.

In at least one specific embodiment, the binder composition can include an aldehyde scavenger and an aldehyde-based resin. The aldehyde scavenger can include a urea-formaldehyde resin that can have a formaldehyde to urea molar ratio of about 1.5:1 to about 2.2:1, a sulfite compound, an ammonium salt, free urea, and a liquid medium. The aldehyde scavenger can have a total formaldehyde to total urea molar ratio of about 0.3:1 to about 0.8:1. The aldehyde scavenger can include about 0.5 wt % to about 4 wt % of the sulfite compound and about 0.5 wt % to about 4 wt % of the ammonium salt, based on a combined weight of the urea-formaldehyde resin, the sulfite compound, the ammonium salt, the free urea, and the liquid medium. The aldehyde-based resin can include a second urea-formaldehyde resin, a phenol-formaldehyde resin, a melamine-formaldehyde resin, a melamine-urea-formaldehyde resin, a melamine-urea-phenol-formaldehyde resin, a resorcinol-formaldehyde resin, a phenol-resorcinol-formaldehyde resin, or any mixture thereof.

### DETAILED DESCRIPTION

It has been surprisingly and unexpectedly discovered that the effectiveness of an aldehyde scavenger that includes a urea-formaldehyde resin, free urea, and a liquid medium can be significantly improved by adding one or more sulfite compounds and one or more ammonium salts thereto. For example, the addition of the sulfite compound and the ammonium salt can increase the stability of the aldehyde scavenger, increase the viscosity of the aldehyde scavenger, and/or facilitate an increase in the urea solids content of the aldehyde scavenger as compared to a comparative aldehyde scavenger that does not include the sulfite compound and the ammonium salt. As such, a greater amount of urea can be shipped per given volume and/or stored for longer periods of time until needed. The aldehyde scavenger can be made by mixing, blending, or otherwise combining a urea-formaldehyde resin, urea, the sulfite compound, the ammonium salt, and the liquid medium in any order or sequence with respect to one another. The aldehyde scavenger can be mixed, blended, or otherwise combined with one or more aldehyde-based resins to produce a binder composition or resin having reduced aldehyde emissions as compared to the resin without the aldehyde scavenger. The binder composition or resin can be used to make composite lignocellulose products. The aldehyde scavenger can include the urea-formaldehyde resin, the sulfite compound, the ammonium salt, the free urea, and the liquid medium when combined with the aldehyde-based resin to produce the low aldehyde emission resin. The aldehyde scavenger can be formed in the presence of the aldehyde-based resin by combining the components of the aldehyde scavenger in the presence of the aldehyde-based resin.

The aldehyde scavenger can include the sulfite compound in an amount of about 0.1 wt % about 0.3 wt %, about 0.5 wt %, about 0.7 wt %, about 1 wt %, about 1.3 wt %, about 1.5 wt %, or about 2 wt % to about 2.5 wt %, about 3 wt %, about 3.5 wt %, about 4 wt %, or about 4.5 wt %, based on a combined weight of the urea-formaldehyde resin, the sulfite compound, the ammonium salt, the free urea, and the liquid medium. For example, the aldehyde scavenger can include about 0.5 wt % to about 4 wt %, about 1 wt % to about 3 wt %, about 1 wt % to about 2 wt %, about 0.7 wt % to about 1.5 wt %, about 2 wt % to about 3.5 wt %, about 2.2 wt % to about 3 wt %, or about 1 wt % to about 1.7 wt % of the sulfite compound, based on the combined weight of the urea-formaldehyde resin, the sulfite compound, the ammonium salt, the free urea, and the liquid medium. In another example, the aldehyde scavenger can include at least 0.5 wt %, at least 0.6 wt %, at least 0.7 wt %, at least 0.8 wt %, at least 0.9 wt %, at least 1 wt %, at least 1.1 wt %, or at least 1.2 wt % and up to about 2 wt %, about 2.5 wt %, about 3 wt %, about 3.5 wt %, about 4 wt %, or about 4.5 wt % of the sulfite compound, based on the combined weight of the urea-formaldehyde resin, the sulfite compound, the ammonium salt, the free urea, and the liquid medium.

The aldehyde scavenger can include the ammonium salt in an amount of about 0.1 wt %, about 0.3 wt %, about 0.5 wt %, about 0.7 wt %, about 1 wt %, about 1.3 wt %, about 1.5 wt %, or about 2 wt % to about 2.5 wt %, about 3 wt %, about 3.5 wt %, about 4 wt %, or about 4.5 wt %, based on the combined weight of the urea-formaldehyde resin, the sulfite compound, the ammonium salt, the free urea, and the liquid medium. In another example, aldehyde scavenger can include about 0.5 wt % to about 4 wt %, about 1 wt % to about 3 wt %, about 1 wt % to about 2 wt %, about 0.7 wt % to about 1.5 wt %, about 2 wt % to about 3.5 wt %, about 2.2 wt % to about 3 wt %, or about 1 wt % to about 1.7 wt % of the ammonium salt, based on the combined weight of the urea-formaldehyde resin, the sulfite compound, the ammonium salt, the free urea, and the liquid medium. In another example, the aldehyde scavenger can include at least 0.5 wt %, at least 0.6 wt %, at least 0.7 wt %, at least 0.8 wt %, at least 0.9 wt %, at least 1 wt %, at least 1.1 wt %, or at least 1.2 wt % and up to about 2 wt %, about 2.5 wt %, about 3 wt %, about 3.5 wt %, about 4 wt %, or about 4.5 wt % of the ammonium salt, based on the combined weight of the urea-formaldehyde resin, the sulfite compound, the ammonium salt, the free urea, and the liquid medium.

The aldehyde scavenger include the sulfite compound and the ammonium salt in a combined amount of at least 0.2 wt %, at least 0.4 wt %, at least 0.6 wt %, at least 0.8 wt %, at least 1 wt %, at least 1.1 wt %, at least 1.2 wt %, at least 1.3 wt %, at least 1.4 wt %, at least 1.5 wt %, at least 1.6 wt %, at least 1.7 wt %, at least 1.8 wt %, at least 1.9 wt %, or at least 2 wt % and up to about 3 wt %, about 4 wt %, about 5 wt %, about 6 wt %, about 7 wt %, about 8 wt %, or about 9 wt %, based on the combined weight of the urea-formaldehyde resin, the sulfite compound, the ammonium salt, the free urea, and the liquid medium. For example, the aldehyde scavenger can include the sulfite compound and the ammonium salt in a combined amount of about 1 wt % to about 3 wt %, about 1.5 wt % to about 4 wt %, about 2 wt % to about 4.5 wt %, about 2.4 wt % to about 6 wt %, about 3 wt % to about 8 wt %, about 2.2 wt % to about 3 wt %, or about 2 wt % to about 4 wt %, based on the combined weight of the urea-formaldehyde resin, the sulfite compound, the ammonium salt, the free urea, and the liquid medium.

The sulfite compound can be or include one or more alkali metal sulfites, one or more alkali metal bisulfites, or mixtures of one or more alkali metal sulfites and/or one or more alkali metal bisulfites. For example, some chemical compounds that can produce sulfite ions upon dissolution can include, but are not limited to, sodium sulfite, sodium bisulfite, potassium sulfite, potassium bisulfite, or any mixture thereof. Illustrative ammonium salts can include, but are not limited to, ammonium sulfate, ammonium chloride, ammonium iodide, ammonium phosphate, ammonium carbonate, ammonium nitrate, or any mixture thereof. In at least one example, the sulfite compound can be or include sodium sulfite and the ammonium salt can be or include ammonium sulfate.

The urea-formaldehyde resin in the aldehyde scavenger can have a molar ratio of formaldehyde to urea of about 1.3:1, about 1.4:1, about 1.5:1, about 1.6:1, or bout 1.7:1 to about 1.8:1, about 1.9:1, about 2:1, about 2.2:1, about 2.3:1, or about 2.4:1. For example, the urea-formaldehyde resin can have a formaldehyde to urea molar ratio of about 1.5:1 to about 2.2:1, about 1.6:1 to about 2.1:1, about 1.65:1 to about 2.15:1, about 1.65:1 to about 2:1, about 1.75:1 to about 1.95:1, about 1.55:1 to about 2.15:1, about 1.85:1 to about 2.2:1, about 1.95:1 to about 2.1:1, or about 1.7:1 to about 2.1:1. In another example, the urea-formaldehyde resin can have a formaldehyde to urea molar ratio of at least 1.5:1, at least 1.55:1, at least 1.6:1, at least 1.65:1, at least 1.7:1, at least 1.75:1, at least 1.8:1, at least 1.85:1, or at least 1.9:1 and up to about 2:1, about 2.05:1, about 2.1:1, about 2.15:1, about 2.2:1, about 2.3:1, or about 2.4:1.

The aldehyde scavenger can have a total formaldehyde to total urea molar ratio of about 0.25:1, about 0.3:1, about 0.35:1, about 0.4:1, about 0.45:1, about 0.5:1, or about 0.55:1 to about 0.6:1, about 0.65:1, about 0.7:1, about 0.75:1, about 0.8:1, or about 0.85:1. For example, the aldehyde scavenger can have a total formaldehyde to total urea molar ratio of about 0.3:1 to about 0.8:1, about 0.25:1 to about 0.45:1, about 0.3:1 to about 0.4:1, about 0.3:1 to about 0.5:1, about 0.35:1 to about 0.4:1, about 0.4:1 to about 0.6:1, about 0.5:1 to about 0.7:1, or about 0.6:1 to about 0.8:1. In another example, the aldehyde scavenger can have a total formaldehyde to total urea molar ratio of at least 0.3:1, at least 0.33:1, at least 0.35:1, at least 0.37:1, at least 0.4:1, at least 0.43:1, or at least 0.45:1 and less than 0.8:1, less than 0.75:1, less than 0.7:1, less than 0.65:1, less than 0.6:1, less than 0.55:1, or less than 0.5:1. The total urea in the aldehyde scavenger includes the urea in the urea-formaldehyde resin and the free urea.

The aldehyde scavenger can include the liquid medium in an amount of about 5 wt %, about 10 wt %, about 15 wt %, about 20 wt %, or about 25 wt % to about 35 wt %, about 40 wt %, about 45 wt %, about 50 wt %, about 55 wt %, or about 60 wt %, based on the combined weight of the urea-formaldehyde resin, the sulfite compound, the ammonium salt, the free urea, and the liquid medium. For example, the aldehyde scavenger can include about 10 wt % to about 60 wt %, about 5 wt % to about 20 wt %, about 15 wt % to about 40 wt %, about 30 wt % to about 50 wt %, about 20 wt % to about 45 wt %, about 3 wt % to about 35 wt %, about 7 wt % to about 45 wt %, about 10 wt % to about 40 wt %, about 30 wt % to about 40 wt %, or about 30 wt % to about 45 wt % of the liquid medium, based on the combined weight of the urea-formaldehyde resin, the sulfite compound, the ammonium salt, the free urea, and the liquid medium. In another example, the aldehyde scavenger can include about 5 wt %, about 10 wt %, about 15 wt %, or about 20 wt % to less than 60 wt %, less than 50 wt %, less than 45 wt %, less than 40 wt %, less than 37 wt %, less than 35 wt %, less than 33 wt %, or less than 30 wt % of the liquid medium, based on the combined weight of the urea-formaldehyde resin, the sulfite compound, the ammonium salt, the free urea, and the liquid medium.

The aldehyde scavenger can have a non-volatile or solids content of at least 40 wt %, at least 43 wt %, at least 45 wt %, at least 47 wt %, at least 50 wt %, at least 53 wt %, at least 55 wt %, at least 57 wt %, at least 60 wt %, at least 63 wt %, at least 65 wt %, at least 67 wt %, at least 70 wt %, at least 73 wt %, at least 75 wt %, at least 77 wt %, or at least 80 wt %, based on the combined weight of the urea-formaldehyde resin, the sulfite compound, the ammonium salt, the free urea, and the liquid medium. For example, the aldehyde scavenger can have a solids content of about 45 wt %, about 47 wt %, about 50 wt %, about 53 wt %, or about 55 wt % to about 60 wt %, about 63 wt %, about 65 wt %, about 67 wt %, about 70 wt %, about 73 wt %, about 75 wt %, about 77 wt %, about 80 wt %, about 85 wt %, or about 90 wt %, based on the combined weight of the urea-formaldehyde resin, the sulfite compound, the ammonium salt, the free urea, and the liquid medium. In another example, the aldehyde scavenger can have a solids content of about 40 wt % to about 55 wt %, about 40 wt % to about 70 wt %, about 55 wt % to about 65 wt %, about 60 wt % to about 65 wt %, about 55 wt % to about 67 wt %, about 57 wt % to about 75 wt %, about 60 wt % to about 70 wt %, about 63 wt % to about 68 wt %, about 62 wt % to about 75 wt %, or about 65 wt % to about 80 wt %, based on the combined weight of the urea-formaldehyde resin, the sulfite compound, the ammonium salt, the free urea, and the liquid medium.

As used herein, the non-volatile or solids content of a solution or solid/liquid mixture, e.g., the aldehyde scavenger, as understood by those skilled in the art, can be measured by determining the weight loss upon heating a small sample, e.g., about 1 gram to about 5 grams of the mixture, to a suitable temperature, e.g., about 125° C., and a time sufficient to remove the liquid medium combined therewith. By measuring the weight of the sample before and after heating, the percent solids in the sample can be directly calculated or otherwise estimated.

The viscosity of the aldehyde scavenger can be about 10 cP, about 100 cP, about 250 cP, about 350 cP, about 500 cP, or about 700 cP to about 1,000 cP, about 1,250 cP, about 1,500 cP, about 2,000 cP, or about 2,200 cP at a temperature of about 25° C. In another example, the aldehyde scavenger can have a viscosity of about 100 cP to about 1,000 cP, about 10 cP to about 25 cP, about 100 cP to about 200 cP, about 275 cP to about 525 cP, about 525 cP to about 725 cP, about 725 cP to about 1,100 cP, about 1,100 cP to about 1,600 cP, about 1,600 cP to about 1,900 cP, or about 1,900 cP to about 2,200 cP at a temperature of about 25° C. In at least one example, the aldehyde scavenger can have a viscosity of about 10 cP, about 100 cP, about 250 cP, about 350 cP, about 500 cP, or about 700 cP to about 1,000 cP, about 1,250 cP, about 1,500 cP, about 2,000 cP, or about 2,200 cP at a temperature of about 25° C. when the aldehyde scavenger has a solids content of about 40 wt % to about 55 wt %, based on the combined weight of the urea-formaldehyde resin, the sulfite compound, the ammonium salt, the free urea, and the liquid medium. The viscosity of the aldehyde scavenger and/or any other compound or composition discussed and described herein can be determined using a viscometer at a temperature of about 25° C. For example, a Brookfield Viscometer, Model DV-II+, with a small sample adapter with, for example, a number 31 spindle, can be used. The small sample adapter can allow the sample to be cooled or heated by the chamber jacket to maintain the temperature of the sample surrounding the spindle at a temperature of about 25° C.

The aldehyde scavenger can have a pH of about 6.5, about 6.7, about 7, about 7.3, or about 7.5 to about 8, about 8.3, about 8.5, about 8.7, or about 9. For example, the aldehyde scavenger can have a pH of about 6.7 to about 7.6, about 7 to about 8, about 7 to about 8.5, about 7 to about 9, about 7.3 to about 8.3, about 7.5 to about 8.5, or about 7 to about 7.8. In another example, the aldehyde scavenger can have a pH of about 6.5, about 6.7, about 7, about 7.3, or about 7.5 to about 8, about 8.3, about 8.5, about 8.7, or about 9 at a temperature of about 25° C. when the aldehyde scavenger has a solids content of about 40 wt % to about 55 wt %, based on the combined weight of the urea-formaldehyde resin, the sulfite compound, the ammonium salt, the free urea, and the liquid medium. The liquid medium can be or include water.

The aldehyde scavenger can be stored on site for future use or transported to another location and stored. For example, the aldehyde scavenger can have a storage stability or shelf life at room temperature, e.g., about 25° C., of about 1 day or more, about 2 days or more, about 3 days or more, about 4 days or more, about 5 days or more, about 6 days or more, about 1 week or more, about 2 weeks or more, about 3 weeks or more, or about 4 weeks or more. For example, the aldehyde scavenger can have a storage stability or shelf life at room temperature, e.g., about 25° C., of at least 1 week, at least 2 weeks, at least 3 weeks, at least 1 month, at least 3 months, at least 6 months, at least 9 months, or at least 12 months. In another example, the aldehyde scavenger can be storage stable at a temperature of about 25° C. for about 1 week, about 2 weeks, about 3 weeks, about 1 month, about 3 month, about 5 months, about 7 months, about 10 months, about 11 months, about 12 months, or longer. As used herein, the terms “storage stability” and “shelf life” are used interchangeably and refer to the time required for one to visually detect the precipitation of matter on the bottom of a storage vessel containing the aldehyde scavenger. The aldehyde scavenger can be maintained at a temperature of about 25° C., e.g., about 22° C. to about 28° C., during measurement of the storage stability.

In one example, the aldehyde scavenger can have a solids content of at least 40 wt % and be storage stable at a temperature of about 25° C. for at least 3 days, at least 5 days, at least 1 week, at least 2 weeks, at least 3 weeks, at least 1 month, at least 2 months, at least 3 months, at least 4 months, at least 5 months, at least 6 months, at least 7 months, at least 8 months, at least 9 months, at least 10 months, at least 11 months, or at least 12 months. In another example, the aldehyde scavenger can have a solids content of at least 45 wt % and be storage stable at a temperature of about 25° C. for at least 3 days, at least 5 days, at least 1 week, at least 2 weeks, at least 3 weeks, at least 1 month, at least 2 months, at least 3 months, at least 4 months, at least 5 months, at least 6 months, at least 7 months, at least 8 months, at least 9 months, at least 10 months, at least 11 months, or at least 12 months. In another example, the aldehyde scavenger can have a solids content of at least 50 wt % and be storage stable at a temperature of about 25° C. for at least 3 days, at least 5 days, at least 1 week, at least 2 weeks, at least 3 weeks, at least 1 month, at least 2 months, at least 3 months, at least 4 months, at least 5 months, at least 6 months, at least 7 months, at least 8 months, at least 9 months, at least 10 months, at least 11 months, or at least 12 months. In another example, the aldehyde scavenger can have a solids content of at least 55 wt % and be storage stable at a temperature of about 25° C. for at least 3 days, at least 5 days, at least 1 week, at least 2 weeks, at least 3 weeks, at least 1 month, at least 2 months, at least 3 months, at least 4 months, at least 5 months, at least 6 months, at least 7 months, at least 8 months, at least 9 months, at least 10 months, at least 11 months, or at least 12 months. In another example, the aldehyde scavenger can have a solids content of at least 60 wt % and be storage stable at a temperature of about 25° C. for at least 3 days, at least 5 days, at least 1 week, at least 2 weeks, at least 3 weeks, at least 1 month, at least 2 months, at least 3 months, at least 4 months, at least 5 months, at least 6 months, at least 7 months, at least 8 months, at least 9 months, at least 10 months, at least 11 months, or at least 12 months. In another example, the aldehyde scavenger can have a solids content of at least 65 wt % and be storage stable at a temperature of about 25° C. for at least 3 days, at least 5 days, at least 1 week, at least 2 weeks, at least 3 weeks, at least 1 month, at least 2 months, at least 3 months, at least 4 months, at least 5 months, at least 6 months, at least 7 months, at least 8 months, at least 9 months, at least 10 months, at least 11 months, or at least 12 months.

The aldehyde scavenger can retain solubility at low temperatures, e.g., a temperature of less than 22° C. The aldehyde scavenger can form less precipitate at a given low temperature than a comparative aldehyde scavenger that is the same, but does not contain the sulfite compound and the ammonium salt. For example, the aldehyde scavenger can have a solids content of at least 40 wt %, at least 45 wt %, at least 50 wt %, at least 55 wt %, at least 60 wt %, or at least 65 wt % and can be storage stable at a temperature of about 8° C., about 10° C., or about 12° C. to about 15° C., about 17° C., or about 20° C. for at least 3 days, at least 5 days, at least 1 week, at least 2 weeks, at least 3 weeks, at least 1 month, at least 2 months, at least 3 months, at least 4 months, at least 5 months, at least 6 months, at least 7 months, at least 8 months, at least 9 months, at least 10 months, at least 11 months, or at least 12 months. Also, if a precipitate does form in the aldehyde scavenger at a low temperature, the precipitate can readily re-solubilize upon heating, e.g., to a temperature greater than about 20° C. These solubility properties can provide a broad temperature range at which the aldehyde scavenger can be stored while still retaining its efficacy as an aldehyde scavenger.

The sulfite compound and the ammonium salt can be added to the urea-formaldehyde resin directly during synthesis of the urea-formaldehyde resin, after the urea-formaldehyde resin has been synthesized, or both. For example, the sulfite compound and the ammonium salt can be mixed with a reaction mixture that can include urea and formaldehyde, an intermediate reaction mixture that can include urea, formaldehyde, and urea-formaldehyde resin, and/or the urea-formaldehyde resin to produce the aldehyde scavenger. The sulfite compound and the ammonium salt can be mixed, blended, stirred, or otherwise combined with the reaction mixture, the intermediate mixture, and/or the urea-formaldehyde resin in any manner to produce the aldehyde scavenger. The sulfite compound and/or the ammonium salt can undergo a chemical reaction to form a chemical bond with the urea-formaldehyde resin and/or remain as an individual or discrete component when mixed with the urea-formaldehyde resin. The sulfite compound and/or the ammonium salt can be added with the urea-formaldehyde resin as a solid and/or a liquid. The sulfite compound and/or the ammonium salt can be in the form of a solution when added with the urea-formaldehyde resin. Suitable solvents for forming a solution that includes the sulfite compound and/or the ammonium salt can include, but are not limited to, water, one or more organic solvents, or any mixture thereof.

The urea for making the urea-formaldehyde resin can be provided in many forms. Solid urea, solutions of urea, and/or urea combined with another moiety can be used. For example, urea can be combined with another moiety, such as formaldehyde and/or urea-formaldehyde adducts, often in aqueous solution. Illustrative urea-formaldehyde products can include, but are not limited to, urea-formaldehyde concentrate (“UFC”). These types of products can include those discussed and described in U.S. Pat. Nos. 5,362,842 and 5,389,716, for example.

The free urea in the aldehyde scavenger can be provided as solid urea, a solution of urea, or a mixture thereof. The free urea in the aldehyde scavenger can be added when making the urea-formaldehyde resin, e.g., excess urea can be added to produce the mixture of urea and formaldehyde that can be reacted to produce the urea-formaldehyde resin, during synthesis of the urea-formaldehyde resin, and/or after the urea-formaldehyde resin has been synthesized.

Even though melamine is also reactive with formaldehyde, for purpose of the present disclosure “melamine” can be expressly excluded from the aldehyde scavenger. As used herein, the term “substantially free from melamine” means the aldehyde scavenger contains less than 10 wt %, less than about 9.5 wt %, less than 9 wt %, less than 8.5 wt %, less than 8 wt %, less than 7 wt %, less than 6 wt %, less than 5 wt %, less than 4 wt %, less than 3 wt %, less than 2 wt %, less than 1 wt %, less than 0.5 wt %, less than about 0.1 wt %, less than 0.05 wt %, less than 0.01 wt %, less than 0.005 wt %, or less than about 0.001 wt %, or less than 0.0005 wt % of melamine, based on a total solids weight of the aldehyde scavenger. In at least one example, the aldehyde scavenger can be free from melamine. Said another way, the aldehyde scavenger can contain no melamine.

Formaldehyde for making the urea-formaldehyde resin can be provided in many forms. The formaldehyde can be or include paraformaldehyde (solid, polymerized formaldehyde), formalin solutions (aqueous solutions of formaldehyde, sometimes with methanol, in 37%, 44%, or 50% formaldehyde concentrations), urea-formaldehyde concentrate (“UFC”), and/or formaldehyde gas can be used.

One or more acids, one or more bases, or any combination thereof can be used to adjust the pH and/or polymerize the urea-formaldehyde resin. Illustrative acids can include, but are not limited to, sulfuric acid, maleic acid, glacial acetic acid, formic acid, urea-sulfonic acid, or any mixture thereof. Suitable acids can include one or more Lewis acids. Illustrative Lewis acids can include, but are not limited to, aluminum chloride, zinc chloride, aluminum bromide, boron fluoride, or any mixture thereof. Suitable bases can include alkali metal and alkali earth hydroxides, alkali metal and alkali earth carbonates, amines, or any mixture thereof. Illustrative alkali metal and alkali earth hydroxides can include, but are not limited to, lithium hydroxide, sodium hydroxide, and potassium hydroxide. Illustrative alkali metal carbonates can include, but are not limited to, sodium carbonate and potassium carbonate. Illustrative amines can include, but are not limited to, ammonia, triethylenetetramine, diethylenetriamine, GP® 4590 k-20 precatalyst (available from Georgia-Pacific® Chemicals LLC). The amount of the acid and/or base can be from about 0.2 wt % to about 6 wt %, preferably from about 0.5 wt % to about 3 wt %, based on the combined weight of the urea-formaldehyde resin and acid and/or base. The acid and/or base can be added initially to the formaldehyde and urea reaction mixture or the acid and/or base can be added incrementally in two or more additions or continuously over time.

The liquid medium can be or include, but is not limited to, water, one or more alcohols, one or more ethers, or any mixture thereof. Illustrative alcohols can include, but are not limited to, methanol, ethanol, propanol, isopropanol, n-butanol, sec-butanol, isobutanol, tert-butanol, ethylene glycol, or any mixture thereof. Illustrative ethers can include, but are not limited to, dimethyl ether, diethyl ether, tetrahydrofuran, or any mixture thereof. Other liquid mediums can include, but are not limited to multifunctional alcohols such as one or more glycols, glycerine, or any mixture thereof. In at least one example, the liquid medium can be or include water.

The aldehyde scavenger can be mixed, blended, or otherwise combined with one or more aldehyde-based resins or “second resins” to produce a binder composition. The binder composition can be used to make one or more lignocellulose composite products. Illustrative lignocellulose composite products can include, but are not limited to, particleboard, fiberboard, panels, and/ plywood. The binder composition can also be used to make one or more fiberglass products.

Examples of suitable aldehyde-based resins or second resins can include, but are not limited to, one or more urea-formaldehyde resins or “second” urea-formaldehyde resins, one or more phenol-formaldehyde resins, one or more melamine-formaldehyde resins, one or more melamine-urea-formaldehyde resins, one or more melamine-urea-phenol-formaldehyde resins, one or more resorcinol-formaldehyde resins, one or more phenol-resorcinol-formaldehyde resins, or any mixture thereof. The second urea-formaldehyde resin can be different than the urea-formaldehyde resin in the aldehyde scavenger. For example, the second urea-formaldehyde resin can have a different weight average molecular weight, a different formaldehyde to urea molar ratio, and/or other property as compared to the urea-formaldehyde resin in the aldehyde scavenger. In one example, an aldehyde-based resin that can benefit from the aldehyde scavenger can include a second urea-formaldehyde that can have a molar ratio of formaldehyde to urea of about 1.05:1 to about 5:1. For such aldehyde-based resins it can be desirable to decrease the aldehyde to urea molar ratio in the aldehyde-based resin to reduce the amount of formaldehyde in the resin. However, the molar ratio can only be reduced so far before performance characteristics of the aldehyde-based resin become affected. For example, internal bond strength of a urea-formaldehyde resin can be reduced when the formaldehyde to urea molar ratio decreases, particularly at molar ratios less than about 1.1:1. Other performance characteristics can include increased glue consumption, deteriorated cold tack, deteriorated strength, and increased swelling. Using the aldehyde scavenger can reduce the concentration of the formaldehyde in the mixture of the aldehyde scavenger and the second resin without a significant reduction in desired performance characteristics.

If the aldehyde-based resin includes a urea-formaldehyde resin or second urea-formaldehyde resin, the second urea-formaldehyde resin can have a formaldehyde to urea molar ratio of at least 1.05:1, at least 1.1:1, at least 1.15:1, at least 1.2:1, at least 1.3:1, at least 1.4:1, or at least 1.5:1 to about 2:1, about 3:1, about 4:1, or about 5:1. For example, if the second resin includes a urea-formaldehyde resin, the second resin can have a formaldehyde to urea molar ratio of about 1.1:1 to about 3.5:1, about 1.2:1 to about 3:1, about 1.15:1 to about 2.5:1, or about 1.1:1 to about 1.3:1.

Many aldehyde-based resins that can be used are commercially available. One particularly useful class of aldehyde-based resins can include those discussed and described in U.S. Pat. No. 5,362,842. Urea-formaldehyde resins such as the types sold by Georgia Pacific Chemicals LLC, e.g., GP® 2928 and GP® 2980, can also be used.

A binder composition that includes the aldehyde scavenger and the aldehyde-based resin can have a molar ratio of total formaldehyde to total urea of less than 1.5:1, less than 1.4:1, less than 1.3:1, less than 1.2:1, less than 1.1:1, less than 1.05:1, or less than 1:1, based on the combined weight of the aldehyde scavenger and the aldehyde-based resin. For example, the binder composition that includes the aldehyde scavenger and the aldehyde-based resin can have a total formaldehyde to total urea molar ratio of about 0.6:1, about 0.7:1, about 0.8:1, about 0.9:1, or about 1:1 to about 1.1:1, about 1.2:1, about 1.3:1, about 1.4:1, or about 1.5:1, based on the combined weight of the aldehyde scavenger and the aldehyde-based resin.

If the second aldehyde-based resin includes urea-formaldehyde resin, the binder composition that includes the aldehyde scavenger and the second aldehyde-based resin can have a molar ratio of total formaldehyde to total urea of less than 1.5:1, less than 1.4:1, less than 1.3:1, less than 1.2:1, less than 1.1:1, less than 1.05:1, or less than 1:1, based on the combined weight of the second aldehyde-based resin and the aldehyde scavenger. For example, a binder composition that includes the aldehyde scavenger and a second urea-formaldehyde resin can have a total formaldehyde to total urea molar ratio of about 0.6:1, about 0.7:1, about 0.8:1, about 0.9:1, or about 1:1 to about 1.1:1, about 1.2:1, about 1.3:1, about 1.4:1, or about 1.5:1, based on the combined weight of the aldehyde scavenger and the second urea-formaldehyde resin. In another example, a binder composition that includes the aldehyde scavenger and a second urea-formaldehyde resin can have a total formaldehyde to total urea molar ratio of about 0.6:1 to about 1.4:1, about 0.6:1 to about 1.3:1, about 0.6:1 to about 1.2:1, about 0.6:1 to about 1.1:1, about 0.6:1 to about 1:1, about 0.65:1 to about 0.95:1, about 0.7:1 to about 0.8:1, about 0.75:1 to about 0.9:1, about 0.75:1 to about 1.1:1, or about 0.65:1 to about 0.85:1, based on the combined weight of the aldehyde scavenger and the second urea-formaldehyde resin.

The binder composition that includes the aldehyde scavenger and the second aldehyde-based resin can include the aldehyde scavenger in an amount of about 0.1 wt %, about 0.5 wt %, about 1 wt %, about 2 wt %, about 3 wt %, about 5 wt %, about 7 wt %, about 10 wt %, about 12 wt %, about 14 wt %, or about 15 wt % to about 20 wt %, about 25 wt %, about 30 wt %, about 35 wt %, about 40 wt %, about 45 wt %, or about 50 wt %, based on the combined solids weight of the aldehyde scavenger and the second aldehyde-based resin. For example, the binder composition can include about 0.1 wt % to about 1 wt %, about 0.7 wt % to about 2 wt %, about 1.5 wt % to about 5 wt %, about 3 wt % to about 10 wt %, about 6 wt % to about 15 wt %, or about 9 wt % to about 20 wt % of the aldehyde scavenger, based on the combined solids weight of the aldehyde scavenger and the second aldehyde-based resin. In other example, the binder composition can include about 5 wt % to about 15 wt %, about 3 wt % to about 8 wt %, about 10 wt % to about 15 wt %, about 12 wt % to about 18 wt %, about 9 wt % to about 14 wt %, about 11 wt % to about 17 wt %, about 20 wt % to about 40 wt %, about 27 wt % to about 43 wt %, about 30 wt % to about 47 wt %, or about 35 wt % to about 50 wt % of the aldehyde scavenger, based on the combined solids weight of the aldehyde scavenger and the second aldehyde-based resin. In at least one example, the aldehyde-based resin can be or include a second urea-formaldehyde resin and the binder composition can include about 1 wt % to about 50 wt %, about 1 wt % to 30 wt %, about 1 wt % to about 20 wt %, about 5 wt % to about 15 wt %, about 10 wt % to about 18 wt %, or about 13 wt % to about 15 wt % of the aldehyde scavenger, based on the combined solids weight of the aldehyde scavenger and the second urea-formaldehyde resin. The aldehyde scavenger can be mixed, blended, or otherwise combined with the aldehyde-based resin at room temperature or at an elevated temperature, e.g., from about 30° C. to about 60° C.

The binder composition that includes the aldehyde scavenger and the second aldehyde-based resin can have a non-volatile or solids content of at least 36 wt %, at least 38 wt %, at least 40 wt %, at least 47 wt %, at least 50 wt %, at least 53 wt %, or at least 55 wt % to about 60 wt %, about 62 wt %, about 64 wt %, about 66 wt %, about 68 wt %, about 70 wt %, about 72 wt %, or about 74 wt %, based on the combined weight of the aldehyde scavenger and the aldehyde-based resin. For example, the binder composition can have a solids content of about 60 wt % to about 70 wt %, about 50 wt % to about 65 wt %, about 58 wt % to about 66 wt %, about 61 wt % to about 69 wt %, about 62 wt % to about 75 wt %, about 63 wt % to about 70 wt %, or about 64 wt % to about 75 wt %, based on the combined weight of the aldehyde-scavenger and the second aldehyde-based resin.

The aldehyde scavenger can be used in place of or in combination with other compounds or compositions capable of scavenging aldehydes. For example, the aldehyde scavenger can be used to replace urea as a scavenger compound in its entirety, or may be used to reduce the amount of urea used as a scavenger in the second aldehyde-based resin.

The binder composition that includes the aldehyde scavenger and the aldehyde-based resin can contain less than 3 wt %, less than 2 wt %, less than 1.5 wt %, less than 1 wt %, less than 0.7 wt %, less than 0.5 wt %, less than 0.4 wt %, less than 0.3 wt %, less than 0.2 wt %, less than 0.1 wt %, less than 0.09 wt %, less than 0.08 wt %, less than 0.07 wt %, less than 0.06 wt %, or less than 0.05 wt % of free formaldehyde. As such, the aldehyde-based resin as well as products made therefrom can exhibit reduced formaldehyde emission while still maintaining a reduced cure time or acceptable rate of cure and/or products having sufficient strength. The amount of free formaldehyde can be measured according ASTM D1979-97.

The binder composition that includes the aldehyde scavenger and the aldehyde-based resin can also include or more additives. Illustrative additives can include, but are not limited to, waxes and/or other hydrophobic additives, water, filler material(s), extenders, surfactants, release agents, dyes, fire retardants, aldehyde scavengers, biocides, or any combination thereof. For composite wood products, such as plywood, typical filler material(s) can include, but are not limited to, ground pecan and/or walnut shells, and typical extenders can include, for example, wheat flour, corn flour, soy flour, or any mixture thereof. Suitable extenders can also include, but are not limited to, polysaccharides, sulfonated lignins, and a mixture thereof. Illustrative polysaccharides can include, but are not limited to, starch, cellulose, gums, such as guar and xanthan, alginates, pectin, gellan, or any mixture thereof. Suitable polysaccharide starches can include, for example maize or corn, waxy maize, high amylose maize, potato, tapioca, and wheat starch. Other starches such as genetically engineered starches can include, but are not limited to, high amylose potato and potato amylopectin starches. Illustrative sulfonated lignins can include, but are not limited to, sodium lignosulfonate, ammonium lignosulfonate, calcium lignosulfonate, or any mixture thereof.

The aldehyde-based resin can also include, but is not limited to, additives such as ammonia, alkanolamines, and/or polyamines, such as an alkyl primary diamine, e.g., ethylenediamine (“EDA”). Other additives, such as ethylene ureas, and primary, secondary and tertiary amines, for example, dicyanodiamide, can also be incorporated into UF resins. Concentrations of these additives in the reaction mixture can vary from about 0.05 wt % to about 20 wt %, based on the solids content of the aldehyde-based resin. The aldehyde-based resin can also have a water dilutability of about 1:1 to about 100:1, for example about 5:1 or greater.

A lignocellulosic composite product can be made by contacting one or more lignocellulosic substrates with the binder composition and at least partially curing the binder composition to produce a composite product. The binder composition can be cured via any number of methods, e.g., with the addition of one or more acids, bases, and/or catalysts, the application of heat and/or pressure, or any combination thereof, to produce the composite product. The amount of acid, base, and/or catalyst that can be added to the binder composition to initiate or start curing of the binder composition can be about 0.01 wt %, about 1 wt %, about 3 wt %, or about 5 wt % to about 10 wt %, about 15 wt %, or about 20 wt %, based on the combined weight of the aldehyde scavenger, aldehyde-based resin, and the acid, base, and/or catalyst.

As used herein, the terms “curing,” “cured,” and similar terms are intended to refer to the structural and/or morphological change that occurs in the resin composition as it is cured to cause covalent chemical reaction (crosslinking), ionic interaction or clustering, improved adhesion to a substrate, phase transformation or inversion, and/or hydrogen bonding. As used herein, the phrases “at least partially cure,” “at least partially cured,” and similar terms are intended to refer to the resin composition that has undergone at least some covalent chemical reaction (crosslinking), ionic interaction or clustering, improved adhesion to the substrate, phase transformation or inversion, and/or hydrogen bonding, but may also be capable of undergoing additional covalent chemical reaction (crosslinking), ionic interaction or clustering, improved adhesion to the substrate, phase transformation or inversion, and/or hydrogen bonding.

The amount of the binder composition applied to the lignocellulose substrates can be from a low of about 1 wt %, about 2 wt %, about 3 wt %, about 4 wt %, about 5 wt % or about 6 wt % to a high of about 10 wt %, about 12 wt %, about 15 wt %, or about 20 wt %, based on a dry weight of the lignocellulose substrates. For example, the mixture or combination of the binder composition and the lignocellulose substrates can include about 1 wt % to about 7 wt %, about 3 wt % to about 15 wt %, about 5 wt % to about 14 wt %, about 6 wt % to about 12 wt %, or about 7 wt % to about 10 wt % of the binder composition, based on the dry weight of the lignocellulose substrates. The lignocellulose composite product can include about 1 wt % to about 7 wt %, about 3 wt % to about 15 wt %, about 5 wt % to about 14 wt %, about 6 wt % to about 12 wt %, or about 7 wt % to about 10 wt % of the cured binder composition, based on the dry weight of the lignocellulose substrates. For example, the lignocellulose composite product can include about 1 wt % to about 4 wt %, about 1.5 wt % to about 5 wt %, about 2 wt % to about 4 wt %, about 2 wt % to about 6 wt %, about 4 wt % to about 10 wt %, about 6 wt % to about 9 wt %, or about 0.5 wt % to about 5.5 wt % of the cured binder composition, based on the dry weight of the lignocellulose substrates.

The binder compositions discussed and described herein can be applied to a plurality of lignocellulose substrates, which can be formed into a desired shape before or after application of the binder composition, and the second aldehyde-based resin can be at least partially cured to produce a lignocellulose composite product. In another example, the binder composition can be applied to wood or other lignocellulose based veneers and/or substrates and the binder composition can be at least partially cured to adhere or otherwise bond the veneer(s) and/or substrate(s) to one another. In another example, the binder composition can be applied to a plurality of lignocellulose fibers, particles, flakes, strands, and/or the like, formed into a mat or board, and at least partially cured to produce a lignocellulose composite product in the form of a mat or board. The plurality of lignocellulose substrates can be randomly oriented, oriented in a desired manner such as in the production of oriented strand board, or a combination of random and oriented substrates can be used in the manufacture of lignocellulose composite products.

The lignocellulose substrates can be contacted with the binder composition by spraying, coating, mixing, brushing, falling film or curtain coating, dipping, soaking, or the like. The lignocellulose substrates contacted with the binder composition can be formed into a desired shape before, during, and/or after at least partial curing of the binder composition. Depending on the particular product, the lignocellulose substrates contacted with the binder composition can be pressed before, during, and/or after the binder composition is at least partially cured. For example, the lignocellulose substrates contacted with the binder composition can be consolidated or otherwise formed into a desired shape, if desired pressed to a particular density and thickness, and heated to at least partially cure the aldehyde-based resin.

The pressure applied to the lignocellulosic substrates and the binder composition during the at least partial cure of the binder composition can depend, at least in part, on the particular product. For example, the amount of pressure applied in a particleboard production process can be from about 1 MPa to about 5 MPa or from about 2 MPa to about 4 MPa. In another example, the amount of pressure applied in a MDF production process can be from about 2 MPa to about 7 MPa or from about 3 MPa to about 6 MPa. The temperature the lignocellulosic substrates and the binder composition can be heated to during the at least partial cure of the binder composition can be from a low of about 100° C., about 125° C., about 150° C., or about 170° C. to a high of about 180° C., about 200° C., about 220° C., or about 250° C. The binder composition at the core or center of the product can be heated to a temperature ranging from a low of about 120° C., about 130° C., about 140° C., about 150° C., or about 155° C. to a high of about 160° C., about 170° C., about 180° C., about 190° C., about 195° C., or about 199° C. The length of time the pressure can be applied can be from a low of about 15 second, about 30 seconds, about 1 minute, about 3 minutes, about 5 minutes, or about 7 minutes to a high of about 10 minutes, about 15 minutes, about 20 minutes, about 30 minutes, about 1 hour, about 2 hours, or more, which can depend, at least in part, on the particular product and/or the particular dimensions, e.g., thickness of the product. For example, the length of time the pressure and/or heat can be applied to the furnish can be from about 30 seconds to about 10 minutes, about 30 seconds to about 2 minutes, about 1 minute to about 3 minutes, about 1.5 minutes to about 4 minutes, or about 45 seconds to about 3.5 minutes.

The lignocellulose substrates (material that includes both cellulose and lignin) can include, but is not limited to, straw, hemp, sisal, cotton stalk, wheat, bamboo, sabai grass, rice straw, banana leaves, paper mulberry (e.g., bast fiber), abaca leaves, pineapple leaves, esparto grass leaves, fibers from the genus Hesperaloe in the family Agavaceae jute, salt water reeds, palm fronds, flax, ground nut shells, hardwoods, softwoods, recycled fiberboards such as high density fiberboard, medium density fiberboard, low density fiberboard, oriented strand board, particleboard, animal fibers (e.g., wool, hair), recycled paper products (e.g., newspapers, cardboard, cereal boxes, and magazines), or any combination thereof. Suitable woods can include softwoods and/or hardwoods. Illustrative types of wood can include, but are not limited to, alder, ash, aspen, basswood, beech, birch, cedar, cherry, cottonwood, cypress, elm, fir, gum, hackberry, hickory, maple, oak, pecan, pine, poplar, redwood, sassafras, spruce, sycamore, walnut, and willow.

The starting material, from which the lignocellulose substrates can be derived from, can be reduced to the appropriate size or dimensions by various processes such as hogging, grinding, hammer milling, tearing, shredding, and/or flaking. Suitable forms of the lignocellulose substrates can include, but are not limited to, chips, flakes, wafers, fibers, shavings, sawdust or dust, or the like. The lignocellulose substrates can have a length ranging from a low of about 0.05 mm, about 0.1 mm, about 0.2 mm to a high of about 1 mm, about 5 mm, about 10 mm, about 20 mm, about 30 mm, about 40 mm, about 50 mm, or about 100 mm.

The starting material, from which the lignocellulose substrates can be derived from, can also be formed into the appropriate size or dimension by skiving, cutting, slicing, sawing, or otherwise removing a thin layer or sheet from a source of lignocellulose material, e.g., a wood log, to produce a veneer or layer. One or more composite products can be produced from two or more veneer. For example, composite products produced with veneer, in finished form, can include those products typically referred to as laminated veneer lumber (“LVL”), laminated veneer boards (“LVB”), and/or plywood. As such, suitable lignocellulose substrates can include, but are not limited to, wood chips, wood fibers, wood flakes, wood strands, wood wafers, wood shavings, wood particles, wood veneer, or any combination thereof.

Depending, at least in part, on the particular product that can incorporate the veneer(s), the veneers can have any suitable shape, e.g., rectangular, circular, or any other geometrical shape. Typically the veneers can be rectangular, and can have a width from a low of about 1 cm, about 5 cm, about 10 cm, about 15 cm, about 20 cm, or about 25 cm to a high of about 0.6 m, about 0.9 m, about 1.2 m, about 1.8 m, or about 2.4 m. The veneers can have a length from a low of about 0.3 m, about 0.6 m, about 0.9 m, about 1.2 m, or about 1.8 m to a high of about 2.4 m, or about 3 m, about 3.6 m, about 4.3 m, about 4.9 m, about 5.5 m, about 6.1 m, about 6.7 m, about 7.3 m, or about 7.9 m. For example, in a typical veneer product such as plywood, the veneers can have a width of about 1.2 m and a length of about 2.4 m. The veneers can have a thickness from a low of about 0.8 mm, about 0.9 mm, about 1 mm, about 1.1 mm or about 1.2 mm to a high of about 3 mm, about 4 mm, about 5 mm, about 6 mm, about 7 mm, about 8 mm, about 9 mm, or about 10 mm.

Illustrative composite wood products or articles produced using the binder composition can include, but are not limited to, particleboard, fiberboard such as medium density fiberboard (“MDF”) and/or high density fiberboard (“HDF”), plywood such as hardwood plywood and/or softwood plywood, oriented strand board (“OSB”), laminated veneer lumber (“LVL”), laminated veneer boards (“LVB”), and the like.

Wood based or wood containing products, such as particleboard, fiberboard, plywood, and oriented strand board, can have a thickness ranging from a low of about 1.5 mm, about 5 mm, or about 10 mm to a high of about 30 mm, about 50 mm, or about 100 mm. Wood based or wood containing products can be formed into sheets or boards. The sheets or boards can have a length of about 1.2 m, about 1.8 m, about 2.4 m, about 3 m, or about 3.6 m. The sheets or boards can have a width of about 0.6 m, about 1.2 m, about 1.8 m, about 2.4 m, or about 3 m.

Another lignocellulose composite product can include panels or other multi-layered products. For example, a lignocellulose product can include two, three, four, five, six, seven, eight, nine, ten, or more individual lignocellulose layers bonded together. The resin composition can be contacted with the lignocellulose substrates of any one or more of the individual layers. In one example, the individual lignocellulose layers of a multi-layer product can be veneer. In another example, the individual lignocellulose layers of a multi-layer product can include a plurality of lignocellulose substrates bonded to one another to produce an individual layer. In another example, a multi-layer lignocellulose product can include one or more individual layers that include veneer and one or more layers that include a plurality of lignocellulose substrates bonded to one another to produce an individual layer.

Composite products in the shape or form of a panel, sheet, board, or the like can be in the form of a rectangular prism that includes six outer surfaces, i.e., three pairs of oppositely facing surfaces. The first pair of oppositely facing surfaces of the composite product can include a first or “top” surface and an opposing second or “bottom” surface. The second and third pairs of oppositely facing surfaces of the composite product can be referred to as the “side surfaces” that have a surface area less than the surface area of the first and second surfaces. As such, composite products in the shape or form of a panel, sheet, board, or the like can have an average thickness, where the average thickness is the length or distance between the first and second surfaces.

If the composite product is in the form of a panel, sheet, board, or the like, the amount or length of time the mixture can be heated can range from a low of about 5 seconds per millimeter (s/mm), about 10 s/mm, about 12 s/mm, or about 15 s/mm to a high of about 17 s/mm, about 19 s/mm, about 21 s/mm, about 23 s/mm, about 25 s/mm, about 27 s/mm, about 30 s/mm, about 35 s/mm, about 40 s/mm, about 50 s/mm, or about 60 s/mm, where the length refers to the average thickness of the composite product. For example, the mixture can be heated for a time of about 7 s/mm to about 27 s/mm, about 9 s/mm to about 24 s/mm, about 11 s/mm to about 22 s/mm, about 8 s/mm to about 20 s/mm, about 14 s/mm to about 18 s/mm, about 6 s/mm to about 14 s/mm, about 10 s/mm to about 18 s/mm, or about 10 s/mm to about 16 s/mm, where the length refers to the average thickness of the composite product. In another example, the mixture can be heated for a time less than 22 s/mm, less than 20 s/mm, less than 18 s/mm, less than 17 s/mm, less than 16 s/mm, less than 15 s/mm, less than 14 s/mm, less than 13 s/mm, or less than 12 s/mm, where the length refers to the average thickness of the composite product. In one specific example, a composite product in the form of a panel, sheet, board, or the like and having an average thickness of about 15 mm and subjected to a total heating time of about 4 minutes would correspond to heating the mixture for about 16 s/mm. In at least one specific example, the mixture can be heated to a temperature of about 160° C. to about 170° C. for a time of 13 s/mm to about 19 s/mm.

The composite product can have an internal bond strength from a low of about 0.3 MPa, about 0.32 MPa, about 0.34 MPa, about 0.35 MPa, about 0.37 MPa, about 0.4 MPa, about 0.42 MPa, about 0.48 MPa, about 0.52 MPa, about 0.55 MPa, or about 0.58 MPa to a high of about 0.69 MPa, about 0.75 MPa, about 0.83 MPa, about 0.9 MPa, about 0.97 MPa, about 1.05 MPa, about 1.15 MPa, about 1.2 MPa, about 1.25 MPa, about 1.3 MPa, about 1.35 MPa, about 1.4 MPa, about 1.45 MPa, about 1.5 MPa, about 1.55 MPa, about 1.6 MPa, or about 1.7 MPa, with suitable ranges including the combination of any two values. For example, the composite product can have an internal bond strength of about 0.35 MPa to about 0.55 MPa, about 0.4 MPa to about 0.6 MPa, about 0.48 MPa to about 0.69 MPa, about 0.59 MPa to about 0.86 MPa, about 0.55 MPa to about 0.9 MPa, or about 0.51 MPa to about 0.85 MPa. In one or more examples, the composite product can have an internal bond strength of at least 0.33 MPa, at least 0.32 MPa, at least 0.34 MPa, at least 0.38 MPa, at least 0.41 MPa, at least 0.45 MPa, at least 0.48 MPa, at least 0.51 MPa, at least 0.55 MPa, at least 0.58 MPa, at least 0.62 MPa, at least 0.66 MPa, at least 0.69 MPa, at least 0.72 MPa, at least 0.76 MPa, or at least 0.79 MPa. The internal bond strength for each example can be determined according to the test procedure provided for in ASTM D1037-96a.

The composite product can have a density from a low of about 0.5 g/cm³, about 0.55 g/cm³, about 0.6 g/cm³, about 0.63 g/cm³, about 0.65 g/cm³, about 0.67 g/cm³, or about 0.7 g/cm³ to a high of about 0.75 g/cm³, about 0.77 g/cm³, about 0.8 g/cm³, about 0.83 g/cm³, about 0.85 g/cm³, about 0.88 g/cm³, about 0.93 g/cm³, about 0.97 g/cm³, about 1 g/cm³, about 1.05 g/cm³, about 1.1 g/cm³, about 1.15 g/cm³, or about 1.2 g/cm³. For example, the composite product can have a density of about 0.7 g/cm³ to about 0.75 g/cm³, about 0.65 g/cm³ to about 0.85 g/cm³, about 0.65 g/cm³ to about 0.8 g/cm³, about 0.67 g/cm³ to about 0.77 g/cm³, about 0.5 g/cm³, to about 1 g/cm³, about 0.5 g/cm³, to about 0.8 g/cm³, about 0.5 g/cm³ to about 0.75 g/cm³, or about 0.64 g/cm³ to about 0.8 g/cm³. In one or more examples, the composite product can have density less than 1 g/cm³, less than 0.95 g/cm³, less than 0.88 g/cm³, less than 0.85 g/cm³, less than 0.83 g/cm³, less than 0.8 g/cm³, less than 0.79 g/cm³, less than 0.78 g/cm³, less than 0.77 g/cm³, less than 0.76 g/cm³, less than 0.75 g/cm³, less than 0.74 g/cm³, or less than 0.73 g/cm³.

In one or more examples, the composite product can have a density less than 1 g/cm³, less than 0.95 g/cm³, less than 0.9 g/cm³, less than 0.85 g/cm³, less than 0.8 g/cm³, less than 0.79 g/cm³, less than 0.78 g/cm³, less than 0.77 g/cm³, less than 0.76 g/cm³, less than 0.75 g/cm³, less than 0.74 g/cm³, or less than 0.73 g/cm³ and an internal bond strength of at least 0.3 MPa, at least 0.35 MPa, at least 0.4 MPa, at least 0.48 MPa, at least 0.51 MPa, at least 0.55 MPa, at least 0.58 MPa, at least 0.62 MPa, at least 0.65 MPa, or at least 0.69 MPa. In at least one specific example, the composite product can have a density less than 0.8 g/cm³ and internal bond strength of at least 0.48 MPa. In at least one other specific example, the composite product can have a density less than 0.8 g/cm³ and internal bond strength of at least 0.69 MPa. In at least one other specific example, the composite product can have a density of less than 0.73 g/cm³ and internal bond strength of at least 0.48 MPa. In still another example, the composite product can have a density of less than 0.73 g/cm³ and internal bond strength of at least 0.58 MPa.

Referring to particleboard in particular, particleboard made according to one or more examples discussed and described herein can meet or exceed the requirements for H-1, H-2, H-3, M-0, M-1, M-S, M-2, M-3i, LD-1, and/or LD-2 grade particleboard as described in the American National Standards Institute (ANSI) for particleboard, i.e., ANSI A208.1-2009 Particleboard, approved Feb. 2, 2009. Particleboard made according to one or more examples discussed and described herein can meet or exceed the requirements for PBU, D-2, D-3, and/or M-3 as defined by ANSI for particleboard, i.e., ANSI A208.1-2009 Particleboard, approved Feb. 2, 2009. For example, Tables A and B set out certain requirements for the different grades of particleboard. Referring to oriented strand board (OSB) in particular, OSB made according to one or more examples discussed and described herein can meet or exceed the U.S. Department of Commerce Voluntary Performance Standard PS 2. Referring to plywood in particular, plywood made according to one or more examples discussed and described herein can meet or exceed the U.S. Department of Commerce Voluntary Performance Standard PS-1 and/or PS-2.

The binder compositions can be used for gluing high average moisture content veneers with reduced blowouts and other moisture induced defects. For example, the binder composition can be mixed, blended, or otherwise combined with lignocellulose substrates having an average moisture content of greater than 7 wt % and up to about 25 wt %, based on the dry weight of the lignocellulose substrates. For example, the lignocellulose substrates can have an average moisture content of about 3 wt %, about 5 wt %, about 7 wt %, about 9 wt %, about 11 wt %, or about 13 wt % to about 17 wt %, about 20 wt %, about 22 wt %, or about 25 wt %, based on the dry weight of the lignocellulose substrates. In another example, the lignocellulose substrates can have an average moisture content from about 3 wt % to about 5 wt %, about 5 wt % to about 7 wt %, about 7 wt % to about 9 wt %, about 9 wt % to about 13 wt %, about 11 wt % to about 15 wt %, or about 13 wt % to about 20 wt % based on the dry weight of the lignocellulose substrates.

The composite lignocellulose containing products produced with the binder compositions discussed and described herein can exhibit a low level of formaldehyde emission. A suitable test for determining formaldehyde emission from a composite wood product that includes an at least partially cured binder composition can include ASTM D6007 and ASTM E1333. For example, the composite lignocellulose containing products containing an at least partially cured resin of the resin composition can exhibit a formaldehyde emission of zero. In another example, the composite lignocellulose containing products containing an at least partially cured aldehyde-based resin can have a formaldehyde emission of less than 5 part per million (“ppm”), less than 4 ppm, less than 3 ppm, less than 2 ppm, less than 1.8 ppm, less than 1.7 ppm, less than 1.6 ppm, less than 1.5 ppm, less than 1.3 ppm, less than 1.1 ppm, or less than 1 ppm.

### EXAMPLES

In order to provide a better understanding of the foregoing discussion, the following non-limiting examples are offered. Although the examples can be directed to specific embodiments, they are not to be viewed as limiting the invention in any specific respect. All parts, proportions, and percentages are by weight unless otherwise indicated.

Three different binder compositions were prepared, namely a first comparative binder composition (C1), a second comparative binder composition (C2), and an inventive binder composition (Ex. 1). The first comparative binder composition (C1) included an aldehyde-based resin and about 0.4 wt % of ammonium sulfate and had a solids content of about 60 wt % to about 70 wt %, but did not include any sulfite compound or free urea. The second comparative binder composition (C2) included the same aldehyde-based resin as the first comparative binder composition (C1) and a comparative aldehyde scavenger. The comparative aldehyde scavenger included a urea-formaldehyde resin having a formaldehyde to urea molar ratio of about 2.1:1, free urea, water, and about 0.4 wt % ammonium sulfate and had a solids content of about 60 wt % to about 70 wt % and a total formaldehyde to total urea molar ratio of about 0.37:1, but was free of any sulfite compound. The inventive binder composition (Ex. 1) included the same aldehyde-based resin as the first and second comparative binder compositions (C1 and C2) and an inventive aldehyde scavenger. The inventive aldehyde scavenger included a urea-formaldehyde resin having a formaldehyde to urea molar ratio of about 2.1:1, free urea, water, about 1 wt % of sodium sulfite, and about 1.4 wt % of ammonium sulfate, and had a solids content of about 60 wt % to about 70 wt % and a total formaldehyde to total urea molar ratio of about 0.37:1. The aldehyde-based resin used in all examples was an aqueous urea-formaldehyde resin that had a formaldehyde to urea molar ratio of about 1.2:1 and a solids content of about 60 wt % to about 70 wt %. Table 1 below shows the systems that were evaluated.

TABLE 1

| | F:U Molar | Aldehyde scavenger | F:U Molar Ratio | Overall |
|---|---|---|---|---|
| | Ratio in the | (14.2 wt % resin | in the Aldehyde | F:U Molar |
| | UF Resin | replacement) | Scavenger | Ratio |
| C1 | 1.2 | None | — | 1.2 |
| C2 | 1.2 | UF resin with no | 0.37 | 1.08 |
| | | sulfite compound | | |
| | | and no ammonium | | |
| | | salt | | |
| Ex. 1 | 1.2 | UF resin with | 0.37 | 1.08 |
| | | sodium sulfite | | |
| | | and ammonium | | |
| | | sulfate | | |

Two sets of particleboard panels were made by combining the binder compositions with southern yellow pine wood furnish (moisture content of about 8 wt %). The wood furnish was added to a ribbon blender and under mechanical blending, the binder compositions were sprayed into the ribbon blender through an atomizer. The amount of the binder composition (urea-formaldehyde resin only (C1)), urea-formaldehyde resin plus the aldehyde scavenger that did not include the sodium sulfite and the ammonium sulfate (C2), and the urea-formaldehyde resin plus the aldehyde scavenger that included the sodium sulfite and the ammonium sulfate (Ex. 1) added to the wood furnish was about 8 wt %, based on the dry weight of the wood furnish.

The first set of particleboard panels was prepared by pressing 30.48 cm×30.48 cm×1.59 cm thick panels and heating to a temperature of about 165.5° C. for 120 seconds, 150 seconds, and 180 seconds for a total of nine different particleboard panels, three particleboard panels for each binder composition. The panels were initially pressed to a pressure of about 600 psi for about 60 seconds. After pressing the panels to about 600 psi, the pressure was reduced to about 200 psi and held at that pressure for about 50 seconds, about 80 second, or about 110 seconds, and the pressure was then released over an additional 10 seconds of time. The internal bond strength for the first set of particleboard panels is shown in Table 2 below. The second set of particleboard panels was prepared by pressing 46.3 cm×46.3 cm×1.27 cm thick panels and heating to a temperature of about 165.5° C. for about 240 seconds. The panels were initially pressed to a pressure of about 600 psi for about 60 seconds. After pressing the panels to about 600 psi, the pressure was reduced to about 200 psi and held at that pressure for about 170 seconds, and the pressure was then released over an additional 10 seconds of time. The target density for all particleboard panels was 0.77 g/cm³. The internal bond (IB) strength of each panel was measured according to the test procedure provided for in ASTM D1037-96a.

TABLE 2

| Example | Press time (s) | IB (MPa) |
|---|---|---|
| C1 | 120 | 0.745 |
| C1 | 150 | 0.848 |
| C1 | 180 | 0.889 |
| C2 | 120 | 0.490 |
| C2 | 150 | 0.607 |
| C2 | 180 | 0.689 |
| Ex. 1 | 120 | 0.414 |
| Ex. 1 | 150 | 0.655 |
| Ex. 1 | 180 | 0.676 |

Table 2 indicates that both binder compositions (C2 and Ex. 1) that included the aldehyde scavenger had comparable internal bond strengths. The internal bond strength data was analyzed using Bayesian Statistics with the WinBugs program. The algorithm used MCMC (Markov Chain Monte Carlo) methods to generate points (10,000 points) that mapped out the curve that best fit the data set. From the simulated data sets the difference of the mean was determined along with the variation of the difference set. If zero is in this difference set (at the 95% confidence level), then the two sets are considered to be statistically equivalent. If zero is not in this difference set, then the two sets are determined to be statistically different at the tested confidence interval. This analysis can be done on a pair of data sets or can be used to compare two curves if several points on the two curves are compared. The analysis indicated that there was no significant difference in the respective means of internal bond strength at all three press times between the C1 and Ex. 1 particleboard panels.

The binder system used in Example 1 that included the addition of sodium sulfite and the additional ammonium salt had a comparable cure speed to the comparative example C2, but a significantly reduced formaldehyde emission. The formaldehyde emitted from two samples of each of the particleboards made with the comparative binder composition (C2) and the inventive composition (Ex. 1) were measured. The formaldehyde emitted from the second set of particleboard panels was measured according to the test procedures UPPM, CPPM, and DPPM. The formaldehyde emission data are shown in Table 3 below.

TABLE 3

| Example | UPPM | CPPM | DPPM | Average (DPPM) |
|---|---|---|---|---|
| C2-1 | 0.150 | 0.160 | 0.168 | 0.167 |
| C2-2 | 0.158 | 0.163 | 0.165 | |
| Ex. 1-1 | 0.141 | 0.151 | 0.156 | 0.151 |
| Ex. 1-2 | 0.127 | 0.137 | 0.145 | |

As shown in Table 3 above, the formaldehyde emission for the resin composition that included the aldehyde scavenger that contained sodium sulfite and the additional ammonium sulfate was significantly reduced by 0.016 ppm (about 10%) as compared to the comparative binder composition that did not include the sodium sulfite and the additional ammonium sulfate. The reduction in formaldehyde emission of the resin composition that included the aldehyde scavenger that contained sodium sulfite and the additional ammonium sulfate was surprising and unexpected.

Embodiments of the present disclosure further relate to any one or more of the following paragraphs:

1. An aldehyde scavenger, comprising: a urea-formaldehyde resin having a formaldehyde to urea molar ratio of about 1.5:1 to about 2.2:1, a sulfite compound, an ammonium salt, free urea, and a liquid medium, wherein: the aldehyde scavenger has a total formaldehyde to total urea molar ratio of about 0.3:1 to about 0.8:1, and the aldehyde scavenger comprises about 0.5 wt % to about 4 wt % of the sulfite compound and about 0.5 wt % to about 4 wt % of the ammonium salt, based on a combined weight of the urea-formaldehyde resin, the sulfite compound, the ammonium salt, the free urea, and the liquid medium.

2. The aldehyde scavenger according to paragraph 1, wherein the aldehyde scavenger has a total formaldehyde to total urea molar ratio of about 0.3:1 to about 0.6:1.

3. The aldehyde scavenger according to paragraphs 1 or 2, wherein the urea-formaldehyde resin has a formaldehyde to urea molar ratio of about 1.5:1 to about 1.8:1.

4. The aldehyde scavenger according to any one of paragraphs 1 to 3, wherein the aldehyde scavenger comprises about 0.5 wt % to about 1.5 wt % of the sulfite compound and about 0.5 wt % to about 1.5 wt % of the ammonium salt, based on the combined weight of the urea-formaldehyde resin, the sulfite compound, the ammonium salt, the free urea, and the liquid medium.

5. The aldehyde scavenger according to any one of paragraphs 1 to 4, wherein the aldehyde scavenger comprises about 0.8 wt % to about 2.5 wt % of the sulfite compound and about 0.8 wt % to about 2.5 wt % of the ammonium salt, based on the combined weight of the urea-formaldehyde resin, the sulfite compound, the ammonium salt, and the free urea.

6. The aldehyde scavenger according to any one of paragraphs 1 to 5, wherein the aldehyde scavenger has a solids content of about 50 wt % to about 70 wt %, based on the combined weight of the urea-formaldehyde resin, the sulfite compound, the ammonium salt, the free urea, and the liquid medium.

7. The aldehyde scavenger according to any one of paragraphs 1 to 6, wherein the aldehyde scavenger has a solids content of about 55 wt % to about 65 wt %, based on the combined weight of the urea-formaldehyde resin, the sulfite compound, the ammonium salt, the free urea, and the liquid medium.

8. The aldehyde scavenger according to any one of paragraphs 1 to 7, wherein the sulfite compound comprises sodium sulfite, sodium bisulfite, potassium sulfite, potassium bisulfite, or any mixture thereof.

9. The aldehyde scavenger according to any one of paragraphs 1 to 8, wherein the ammonium salt comprises ammonium sulfate, ammonium chloride, ammonium iodide, ammonium phosphate, ammonium carbonate, ammonium nitrate, or any mixture thereof.

10. The aldehyde scavenger according to any one of paragraphs 1 to 9, wherein the aldehyde scavenger has a solids content of about 55 wt % to about 65 wt %, based on the combined weight of the urea-formaldehyde resin, the sulfite compound, the ammonium salt, the free urea, and the liquid medium, and wherein the aldehyde scavenger has a storage stability of at least 20 days at a temperature of about 25° C.

11. The aldehyde scavenger according to any one of paragraphs 1 to 10, wherein the aldehyde scavenger has a solids content of about 55 wt % to about 65 wt %, based on the combined weight of the urea-formaldehyde resin, the sulfite compound, the ammonium salt, the free urea, and the liquid medium, and wherein the aldehyde scavenger has a storage stability of at least 6 months at a temperature of about 25° C.

12. The aldehyde scavenger according to any one of paragraphs 1 to 11, further comprising a second urea-formaldehyde resin having a molar ratio of formaldehyde to urea of at least 1.1:1 to about 3:1, wherein the aldehyde scavenger is present in an amount of about 1 wt % to about 50 wt %, based on the combined weight of the aldehyde scavenger and the second urea-formaldehyde resin, wherein a total formaldehyde to a total urea molar ratio is about 0.6:1 to about 1.5:1, based on the combined weight of the aldehyde scavenger and the second urea-formaldehyde resin, and wherein a solids content is from about 50 wt % to about 70 wt %, based on the combined weight of the aldehyde scavenger and the second urea-formaldehyde resin.

13. The aldehyde scavenger according to any one of paragraphs 1 to 12, wherein the aldehyde scavenger is at a pH of about 7 to about 9.

14. The aldehyde scavenger according to any one of paragraphs 1 to 13, wherein the liquid medium comprises water.

15. The aldehyde scavenger according to any one of paragraphs 1 to 14, wherein the aldehyde scavenger has a total formaldehyde to total urea molar ratio of about 0.3:1 to about 0.6:1, wherein the urea-formaldehyde resin has a formaldehyde to urea molar ratio of about 1.5:1 to about 1.8:1, wherein the aldehyde scavenger has a solids content of about 55 wt % to about 65 wt %, based on the combined weight of the urea-formaldehyde resin, the sulfite compound, the ammonium salt, the free urea, and the liquid medium, wherein the sulfite compound comprises sodium sulfite, wherein the ammonium salt comprises ammonium sulfate, wherein the liquid medium comprises water, and wherein the aldehyde scavenger is at a pH of about 7 to about 9.

16. A method for making an aldehyde scavenger, comprising: combining a urea-formaldehyde resin having a formaldehyde to urea molar ratio of about 1.5:1 to about 2.2:1, a sulfite compound, an ammonium salt, urea, and liquid medium with one another to produce an aldehyde scavenger having a total aldehyde to total urea molar ratio of about 0.3:1 to about 0.8:1, wherein the aldehyde scavenger comprises about 0.5 wt % to about 4 wt % of the sulfite compound and about 0.5 wt % to about 4 wt % of the ammonium salt, based on a combined weight of the urea-formaldehyde resin, the sulfite compound, the ammonium salt, the urea, and the liquid medium.

17. The method according to paragraph 16, wherein the aldehyde scavenger has a total formaldehyde to total urea molar ratio of about 0.3:1 to about 0.6:1.

18. The method according to paragraphs 16 or 17, wherein the urea-formaldehyde resin has a formaldehyde to urea molar ratio of about 1.5:1 to about 1.8:1.

19. The method according to any one of paragraphs 16 to 18, wherein the aldehyde scavenger comprises about 0.5 wt % to about 1.5 wt % of the sulfite compound and about 0.5 wt % to about 1.5 wt % of the ammonium salt, based on the combined weight of the urea-formaldehyde resin, the sulfite compound, the ammonium salt, the free urea, and the liquid medium.

20. The method according to any one of paragraphs 16 to 19, wherein the aldehyde scavenger comprises about 0.8 wt % to about 2.5 wt % of the sulfite compound and about 0.8 wt % to about 2.5 wt % of the ammonium salt, based on the combined weight of the urea-formaldehyde resin, the sulfite compound, the ammonium salt, and the free urea.

21. The method according to any one of paragraphs 16 to 20, wherein the aldehyde scavenger has a solids content of about 50 wt % to about 70 wt %, based on the combined weight of the urea-formaldehyde resin, the sulfite compound, the ammonium salt, the free urea, and the liquid medium.

22. The method according to any one of paragraphs 16 to 21, wherein the aldehyde scavenger has a solids content of about 55 wt % to about 65 wt %, based on the combined weight of the urea-formaldehyde resin, the sulfite compound, the ammonium salt, the free urea, and the liquid medium.

23. The method according to any one of paragraphs 16 to 22, wherein the sulfite compound comprises sodium sulfite, sodium bisulfite, potassium sulfite, potassium bisulfite, or any mixture thereof.

24. The method according to any one of paragraphs 16 to 23, wherein the ammonium salt comprises ammonium sulfate, ammonium chloride, ammonium iodide, ammonium phosphate, ammonium carbonate, ammonium nitrate, or any mixture thereof.

25. The method according to any one of paragraphs 16 to 24, wherein the aldehyde scavenger has a solids content of about 55 wt % to about 65 wt %, based on the combined weight of the urea-formaldehyde resin, the sulfite compound, the ammonium salt, the free urea, and the liquid medium, and wherein the aldehyde scavenger has a storage stability of at least 20 days at a temperature of about 25° C.

26. The method according to any one of paragraphs 16 to 25, wherein the aldehyde scavenger has a solids content of about 55 wt % to about 65 wt %, based on the combined weight of the urea-formaldehyde resin, the sulfite compound, the ammonium salt, the free urea, and the liquid medium, and wherein the aldehyde scavenger has a storage stability of at least 6 months at a temperature of about 25° C.

27. The method according to any one of paragraphs 16 to 26, further comprising a second urea-formaldehyde resin having a molar ratio of formaldehyde to urea of at least 1.1:1 to about 3:1, wherein the aldehyde scavenger is present in an amount of about 1 wt % to about 50 wt %, based on the combined weight of the aldehyde scavenger and the second urea-formaldehyde resin, wherein a total formaldehyde to a total urea molar ratio is about 0.6:1 to about 1.5:1, based on the combined weight of the aldehyde scavenger and the second urea-formaldehyde resin, and wherein a solids content is from about 50 wt % to about 70 wt %, based on the combined weight of the aldehyde scavenger and the second urea-formaldehyde resin.

28. The method according to any one of paragraphs 16 to 27, wherein the aldehyde scavenger is at a pH of about 7 to about 9.

29. The method according to any one of paragraphs 16 to 28, wherein the liquid medium comprises water.

30. The method according to any one of paragraphs 16 to 29, wherein the aldehyde scavenger has a total formaldehyde to total urea molar ratio of about 0.3:1 to about 0.6:1, wherein the urea-formaldehyde resin has a formaldehyde to urea molar ratio of about 1.5:1 to about 1.8:1, wherein the aldehyde scavenger has a solids content of about 55 wt % to about 65 wt %, based on the combined weight of the urea-formaldehyde resin, the sulfite compound, the ammonium salt, the free urea, and the liquid medium, wherein the sulfite compound comprises sodium sulfite, wherein the ammonium salt comprises ammonium sulfate, wherein the liquid medium comprises water, and wherein the aldehyde scavenger is at a pH of about 7 to about 9.

31. A method for making a composite product, comprising: contacting a plurality of lignocellulosic substrates with a binder composition comprising an aldehyde scavenger and an aldehyde-based resin to produce a mixture, wherein: the aldehyde scavenger comprises a urea-formaldehyde resin having a formaldehyde to urea molar ratio of about 1.5:1 to about 2.2:1, a sulfite compound, an ammonium salt, free urea, and a liquid medium, the aldehyde scavenger has a total aldehyde to total urea molar ratio of about 0.3:1 to about 0.8:1, and the aldehyde scavenger comprises about 0.5 wt % to about 4 wt % of the sulfite compound and about 0.5 wt % to about 4 wt % of the ammonium salt, based on a combined weight of the urea-formaldehyde resin, the sulfite compound, the ammonium salt, the free urea, and the liquid medium; and at least partially curing the aldehyde-based resin to produce a composite product.

32. The method according to paragraph 31, wherein the aldehyde-based resin comprises a second urea-formaldehyde resin having a molar ratio of formaldehyde to urea of at least 1.1:1 to about 3:1.

33. The method according to paragraph 31 or 32, wherein the mixture comprises about 3 wt % to about 15 wt % of the binder composition, based on a dry weight of the plurality of lignocellulose substrates.

34. The method according to any one of paragraphs 31 to 33, wherein the binder composition comprises about 1 wt % to about 50 wt % of the aldehyde scavenger, based on the combined weight of the aldehyde scavenger and the aldehyde-based resin.

35. The method according to any one of paragraphs 31 to 34, wherein the aldehyde scavenger has a solids content of about 50 wt % to about 70 wt %, based on the combined weight of the urea-formaldehyde resin, the sulfite compound, the ammonium salt, the free urea, and the liquid medium.

36. The method according to any one of paragraphs 31 to 35, wherein the aldehyde-based resin comprises a second urea-formaldehyde resin having a molar ratio of formaldehyde to urea of at least 1.1:1 to about 3:1, and wherein the binder composition has a total formaldehyde to total urea molar ratio of about 0.6:1 to about 1.5:1, based on the combined weight of the aldehyde scavenger and the second urea-formaldehyde resin.

37. The method according to any one of paragraphs 31 to 36, wherein the aldehyde scavenger has a total formaldehyde to total urea molar ratio of about 0.3:1 to about 0.6:1.

38. The method according to any one of paragraphs 31 to 37, wherein the urea-formaldehyde resin has a formaldehyde to urea molar ratio of about 1.5:1 to about 1.8:1.

39. The method according to any one of paragraphs 31 to 38, wherein the aldehyde scavenger comprises about 0.5 wt % to about 1.5 wt % of the sulfite compound and about 0.5 wt % to about 1.5 wt % of the ammonium salt, based on the combined weight of the urea-formaldehyde resin, the sulfite compound, the ammonium salt, the free urea, and the liquid medium.

40. The method according to any one of paragraphs 31 to 39, wherein the aldehyde scavenger comprises about 0.8 wt % to about 2.5 wt % of the sulfite compound and about 0.8 wt % to about 2.5 wt % of the ammonium salt, based on the combined weight of the urea-formaldehyde resin, the sulfite compound, the ammonium salt, and the free urea.

41. The method according to any one of paragraphs 31 to 40, wherein the aldehyde scavenger has a solids content of about 50 wt % to about 70 wt %, based on the combined weight of the urea-formaldehyde resin, the sulfite compound, the ammonium salt, the free urea, and the liquid medium.

42. The method according to any one of paragraphs 31 to 41, wherein the aldehyde scavenger has a solids content of about 55 wt % to about 65 wt %, based on the combined weight of the urea-formaldehyde resin, the sulfite compound, the ammonium salt, the free urea, and the liquid medium.

43. The method according to any one of paragraphs 31 to 42, wherein the sulfite compound comprises sodium sulfite, sodium bisulfite, potassium sulfite, potassium bisulfite, or any mixture thereof.

44. The method according to any one of paragraphs 31 to 43, wherein the ammonium salt comprises ammonium sulfate, ammonium chloride, ammonium iodide, ammonium phosphate, ammonium carbonate, ammonium nitrate, or any mixture thereof.

45. The method according to any one of paragraphs 31 to 44, wherein the aldehyde scavenger has a solids content of about 55 wt % to about 65 wt %, based on the combined weight of the urea-formaldehyde resin, the sulfite compound, the ammonium salt, the free urea, and the liquid medium, and wherein the aldehyde scavenger has a storage stability of at least 20 days at a temperature of about 25° C.

46. The method according to any one of paragraphs 31 to 45, wherein the aldehyde scavenger has a solids content of about 55 wt % to about 65 wt %, based on the combined weight of the urea-formaldehyde resin, the sulfite compound, the ammonium salt, the free urea, and the liquid medium, and wherein the aldehyde scavenger has a storage stability of at least 6 months at a temperature of about 25° C.

47. The method according to any one of paragraphs 31 to 46, wherein the aldehyde scavenger is at a pH of about 7 to about 9.

48. The method according to any one of paragraphs 31 to 47, wherein the liquid medium comprises water.

49. The method according to any one of paragraphs 31 to 48, wherein the aldehyde scavenger has a total formaldehyde to total urea molar ratio of about 0.3:1 to about 0.6:1, wherein the urea-formaldehyde resin has a formaldehyde to urea molar ratio of about 1.5:1 to about 1.8:1, wherein the aldehyde scavenger has a solids content of about 55 wt % to about 65 wt %, based on the combined weight of the urea-formaldehyde resin, the sulfite compound, the ammonium salt, the free urea, and the liquid medium, wherein the sulfite compound comprises sodium sulfite, wherein the ammonium salt comprises ammonium sulfate, wherein the liquid medium comprises water, and wherein the aldehyde scavenger is at a pH of about 7 to about 9.

50. A binder composition comprising: an aldehyde scavenger comprising a urea-formaldehyde resin having a formaldehyde to urea molar ratio of about 1.5:1 to about 2.2:1, a sulfite compound, an ammonium salt, free urea, and a liquid medium, wherein: the aldehyde scavenger has a total formaldehyde to total urea molar ratio of about 0.3:1 to about 0.8:1, and the aldehyde scavenger comprises about 0.5 wt % to about 4 wt % of the sulfite compound and about 0.5 wt % to about 4 wt % of the ammonium salt, based on a combined weight of the urea-formaldehyde resin, the sulfite compound, the ammonium salt, the free urea, and the liquid medium; and an aldehyde-based resin comprising a second urea-formaldehyde resin, a phenol-formaldehyde resin, a melamine-formaldehyde resin, a melamine-urea-formaldehyde resin, a melamine-urea-phenol-formaldehyde resin, a resorcinol-formaldehyde resin, a phenol-resorcinol-formaldehyde resin, or any mixture thereof.

51. The binder composition according to paragraph 50, wherein the binder composition has molar ratio of total formaldehyde to total urea of about 0.6:1 to about 1.4:1.

52. The binder composition according to paragraph 50 or 51, wherein the binder composition comprises about 0.1 wt % to about 50 wt % of the aldehyde scavenger, based on a combined solids weight of the aldehyde scavenger and the aldehyde-based resin.

53. The binder composition according to any one of paragraphs 50 to 52, wherein the aldehyde-based resin comprises the second urea-formaldehyde resin.

54. The binder composition according to any one of paragraphs 50 to 53, wherein the liquid medium comprises water.

55. The binder composition according to any one of paragraphs 50 to 54, wherein the aldehyde scavenger has a total formaldehyde to total urea molar ratio of about 0.3:1 to about 0.6:1.

56. The binder composition according to any one of paragraphs 50 to 55, wherein the urea-formaldehyde resin has a formaldehyde to urea molar ratio of about 1.5:1 to about 1.8:1.

57. The binder composition according to any one of paragraphs 50 to 56, wherein the sulfite compound comprises sodium sulfite, sodium bisulfite, potassium sulfite, potassium bisulfite, or any mixture thereof.

58. The binder composition according to any one of paragraphs 50 to 57, wherein the ammonium salt comprises ammonium sulfate, ammonium chloride, ammonium iodide, ammonium phosphate, ammonium carbonate, ammonium nitrate, or any mixture thereof.

59. The binder composition according to any one of paragraphs 50 to 58, wherein the aldehyde scavenger comprises about 0.5 wt % to about 2.5 wt % of the sulfite compound and about 0.5 wt % to about 2.5 wt % of the ammonium salt, based on the combined weight of the urea-formaldehyde resin, the sulfite compound, the ammonium salt, the free urea, and the liquid medium.

60. An aldehyde scavenger, comprising: a urea-formaldehyde resin having a formaldehyde to urea molar ratio of about 1.5:1 to about 1.8:1, sodium sulfite, ammonium sulfate, free urea, and water.

61. The aldehyde scavenger according to paragraph 60, wherein the aldehyde scavenger has a total formaldehyde to total urea molar ratio of about 0.3:1 to about 0.6:1.

62. The aldehyde scavenger according to paragraph 60 or 61, wherein the aldehyde scavenger comprises about 0.5 wt % to about 2.5 wt % of the sodium sulfite, based on a combined weight of the urea-formaldehyde resin, the sodium sulfite, the ammonium sulfate, the free urea, and the water.

63. The aldehyde scavenger according to any one of paragraphs 60 to 62, wherein the aldehyde scavenger comprises about 0.5 wt % to about 2.5 wt % of the ammonium sulfate, based on a combined weight of the urea-formaldehyde resin, the sodium sulfite, the ammonium sulfate, the free urea, and the water.

64. The aldehyde scavenger according to any one of paragraphs 60 to 64, wherein the aldehyde scavenger has a solids content of about 60 wt % to about 70 wt %, based on a combined weight of the urea-formaldehyde resin, the sodium sulfite, the ammonium sulfate, the free urea, and the water.

65. The aldehyde scavenger according to any one of paragraphs 60 to 63, wherein the aldehyde scavenger has a pH of about 7 to about 9 at a temperature of about 25° C.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. An aldehyde scavenger, comprising:
a urea-formaldehyde resin having a formaldehyde to urea molar ratio of about 1.5:1 to about 2.2:1, a sulfite compound, an ammonium salt, free urea, and a liquid medium, wherein:
the aldehyde scavenger has a total formaldehyde to total urea molar ratio of about 0.3:1 to about 0.8:1, and
the aldehyde scavenger comprises about 0.5 wt % to about 4 wt % of the sulfite compound and about 0.5 wt % to about 4 wt % of the ammonium salt, based on a combined weight of the urea-formaldehyde resin, the sulfite compound, the ammonium salt, the free urea, and the liquid medium.

2. The aldehyde scavenger of claim 1, wherein the aldehyde scavenger has a total formaldehyde to total urea molar ratio of about 0.3:1 to about 0.6:1.

3. The aldehyde scavenger of claim 1, wherein the urea-formaldehyde resin has a formaldehyde to urea molar ratio of about 1.5:1 to about 1.8:1.

4. The aldehyde scavenger of claim 1, wherein the aldehyde scavenger comprises about 0.5 wt % to about 1.5 wt % of the sulfite compound and about 0.5 wt % to about 1.5 wt % of the ammonium salt, based on the combined weight of the urea-formaldehyde resin, the sulfite compound, the ammonium salt, the free urea, and the liquid medium.

5. The aldehyde scavenger of claim 1, wherein the aldehyde scavenger comprises about 0.8 wt % to about 2.5 wt % of the sulfite compound and about 0.8 wt % to about 2.5 wt % of the ammonium salt, based on the combined weight of the urea-formaldehyde resin, the sulfite compound, the ammonium salt, and the free urea.

6. The aldehyde scavenger of claim 1, wherein the aldehyde scavenger has a solids content of about 50 wt % to about 70 wt %, based on the combined weight of the urea-formaldehyde resin, the sulfite compound, the ammonium salt, the free urea, and the liquid medium.

7. The aldehyde scavenger of claim 1, wherein the aldehyde scavenger has a solids content of about 55 wt % to about 65 wt %, based on the combined weight of the urea-formaldehyde resin, the sulfite compound, the ammonium salt, the free urea, and the liquid medium.

8. The aldehyde scavenger of claim 1, wherein the sulfite compound comprises sodium sulfite, sodium bisulfite, potassium sulfite, potassium bisulfite, or any mixture thereof.

9. The aldehyde scavenger of claim 1, wherein the ammonium salt comprises ammonium sulfate, ammonium chloride, ammonium iodide, ammonium phosphate, ammonium carbonate, ammonium nitrate, or any mixture thereof.

10. The aldehyde scavenger of claim 1, wherein the aldehyde scavenger has a solids content of about 55 wt % to about 65 wt %, based on the combined weight of the urea-formaldehyde resin, the sulfite compound, the ammonium salt, the free urea, and the liquid medium, and wherein the aldehyde scavenger has a storage stability of at least 20 days at a temperature of about 25° C.

11. The aldehyde scavenger of claim 1, wherein the aldehyde scavenger has a pH of about 7 to about 9 at a temperature of about 25° C.

12. The aldehyde scavenger of claim 1, wherein the liquid medium comprises water.

13. The aldehyde scavenger of claim 1, wherein:
the liquid medium comprises water,
the aldehyde scavenger has a total formaldehyde to total urea molar ratio of about 0.3:1 to about 0.6:1,
the urea-formaldehyde resin has a formaldehyde to urea molar ratio of about 1.5:1 to about 1.8:1,
the sulfite compound comprises sodium sulfite, sodium bisulfite, potassium sulfite, potassium bisulfite, or any mixture thereof,
the ammonium salt comprises ammonium sulfate, ammonium chloride, ammonium iodide, ammonium phosphate, ammonium carbonate, ammonium nitrate, or any mixture thereof,
the aldehyde scavenger comprises about 0.5 wt % to about 2.5 wt % of the sulfite compound and about 0.5 wt % to about 2.5 wt % of the ammonium salt, based on the combined weight of the urea-formaldehyde resin, the sulfite compound, the ammonium salt, the free urea, and the liquid medium, and
the aldehyde scavenger has a solids content of about 55 wt % to about 70 wt %, based on the combined weight of the urea-formaldehyde resin, the sulfite compound, the ammonium salt, the free urea, and the liquid medium.

14. The aldehyde scavenger of claim 1, wherein:
the aldehyde scavenger has a total formaldehyde to total urea molar ratio of about 0.3:1 to about 0.6:1,
the urea-formaldehyde resin has a formaldehyde to urea molar ratio of about 1.5:1 to about 1.8:1,
the aldehyde scavenger has a solids content of about 55 wt % to about 70 wt %, based on the combined weight of the urea-formaldehyde resin, the sulfite compound, the ammonium salt, the free urea, and the liquid medium,
the sulfite compound comprises sodium sulfite,
the ammonium salt comprises ammonium sulfate,
the liquid medium comprises water, and
the aldehyde scavenger has a pH of about 7 to about 9 at a temperature of about 25° C.

15. An aldehyde scavenger, comprising:
a urea-formaldehyde resin having a formaldehyde to urea molar ratio of about 1.5:1 to about 1.8:1, sodium sulfite, ammonium sulfate, free urea, and water, wherein:
the aldehyde scavenger has a total formaldehyde to total urea molar ratio of about 0.3:1 to about 0.6:1, and
the aldehyde scavenger comprises about 0.5 wt % to about 2.5 wt % of the sodium sulfite and about 0.5 wt % to about 2.5 wt % of the ammonium sulfate, based on a combined weight of the urea-formaldehyde resin, the sodium sulfite, the ammonium sulfate, the free urea, and the water,
the aldehyde scavenger has a pH of about 7 to about 9 at a temperature of about 25° C., and
the aldehyde scavenger has a solids content of about 60 wt % to about 70 wt %, based on a combined weight of the urea-formaldehyde resin, the sodium sulfite, the ammonium sulfate, the free urea, and the water.

16. A binder composition comprising:
an aldehyde scavenger comprising a urea-formaldehyde resin having a formaldehyde to urea molar ratio of about 1.5:1 to about 2.2:1, a sulfite compound, an ammonium salt, free urea, and a liquid medium, wherein:
the aldehyde scavenger has a total formaldehyde to total urea molar ratio of about 0.3:1 to about 0.8:1, and
the aldehyde scavenger comprises about 0.5 wt % to about 4 wt % of the sulfite compound and about 0.5 wt % to about 4 wt % of the ammonium salt, based on a combined weight of the urea-formaldehyde resin, the sulfite compound, the ammonium salt, the free urea, and the liquid medium; and
an aldehyde-based resin comprising a second urea-formaldehyde resin, a phenol-formaldehyde resin, a melamine-formaldehyde resin, a melamine-urea-formaldehyde resin, a melamine-urea-phenol-formaldehyde resin, a resorcinol-formaldehyde resin, a phenol-resorcinol-formaldehyde resin, or any mixture thereof.

17. The binder composition of claim 16, wherein the binder composition has a total formaldehyde to total urea molar ratio of about 0.6:1 to about 1.4:1.

18. The binder composition of claim 16, wherein the binder composition comprises about 0.1 wt % to about 50 wt % of the aldehyde scavenger, based on a combined solids weight of the aldehyde scavenger and the aldehyde-based resin.

19. The binder composition of claim 16, wherein:
the aldehyde-based resin comprises the second urea-formaldehyde resin,
the binder composition has a molar ratio of total formaldehyde to total urea of about 0.6:1 to about 1.4:1, and
the binder composition comprises about 0.1 wt % to about 50 wt % of the aldehyde scavenger, based on a combined solids weight of the aldehyde scavenger and the aldehyde-based resin.

20. The binder composition of claim 16, wherein:
the liquid medium comprises water,
the aldehyde scavenger has a total formaldehyde to total urea molar ratio of about 0.3:1 to about 0.6:1,
the urea-formaldehyde resin has a formaldehyde to urea molar ratio of about 1.5:1 to about 1.8:1,
the sulfite compound comprises sodium sulfite, sodium bisulfite, potassium sulfite, potassium bisulfite, or any mixture thereof,
the ammonium salt comprises ammonium sulfate, ammonium chloride, ammonium iodide, ammonium phosphate, ammonium carbonate, ammonium nitrate, or any mixture thereof,
the aldehyde scavenger comprises about 0.5 wt % to about 2.5 wt % of the sulfite compound and about 0.5 wt % to about 2.5 wt % of the ammonium salt, based on the combined weight of the urea-formaldehyde resin, the sulfite compound, the ammonium salt, the free urea, and the liquid medium,
the aldehyde-based resin comprises the second urea-formaldehyde resin,
the binder composition has a molar ratio of total formaldehyde to total urea of about 0.6:1 to about 1.4:1, and
the binder composition comprises about 0.1 wt % to about 50 wt % of the aldehyde scavenger, based on a combined solids weight of the aldehyde scavenger and the aldehyde-based resin.
